(19) United States
(12) Patent Application Publication
(10) Pub. No.: US 2016/0297165 A1
(43) Pub. Date: Oct. 13, 2016

(54) Door Cover

(71) Applicants: Robert John Bogart, Washington, DC (US); Rachel Lynn Bogart, Washington, DC (US)

(72) Inventors: Robert John Bogart, Washington, DC (US); Rachel Lynn Bogart, Washington, DC (US)

(21) Appl. No.: 15/094,355

(22) Filed: Apr. 8, 2016

Related U.S. Application Data
(60) Provisional application No. 62/145,711, filed on Apr. 10, 2015.

(51) Int. Cl. B32B 3/06; A47H 23/08; B32B 3/08; E06B 3/70

(52) U.S. Cl. CPC B32B 3/06; E06B 3/7001; A47H 23/08; B32B 3/08; A47H 2023/025

(57) ABSTRACT

An apparatus configured to mount on a door comprises a panel, an upper elastic sleeve, and a lower elastic sleeve. The top side of panel is attached to the upper sleeve. The lower side of the panel is attached to the lower sleeve. The panel may comprise an image.

### CROSS-REFERENCE TO RELATED APPLICATIONS

This application claims the benefit of U.S. Provisional Application No. 62/145,711, filed Apr. 10, 2015, titled “Door Cover,” which is hereby incorporated by reference in its entirety.

### BRIEF DESCRIPTION OF THE SEVERAL VIEWS OF THE DRAWINGS

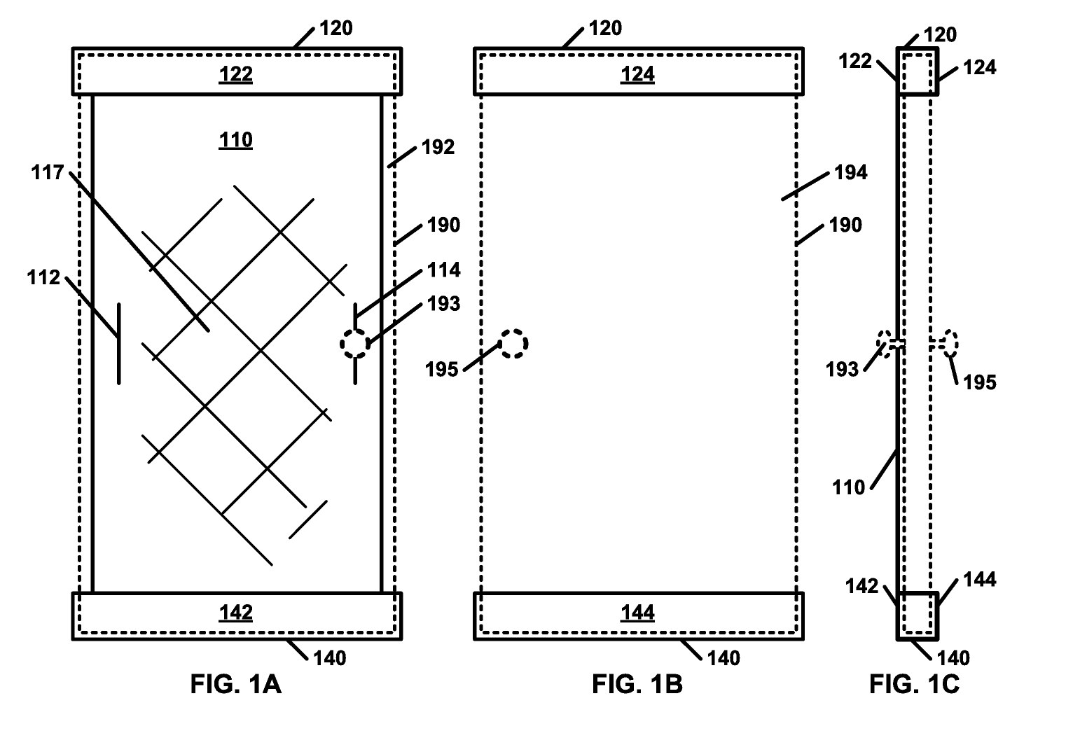

Example FIG. 1A is a front view diagram of a door cover mounted on a door as per an aspect of an embodiment of the present invention.

Example FIG. 1B is a rear view diagram of a door cover mounted on a door as per an aspect of an embodiment of the present invention.

Example FIG. 1C is a side view diagram of a door cover mounted on a door as per an aspect of an embodiment of the present invention.

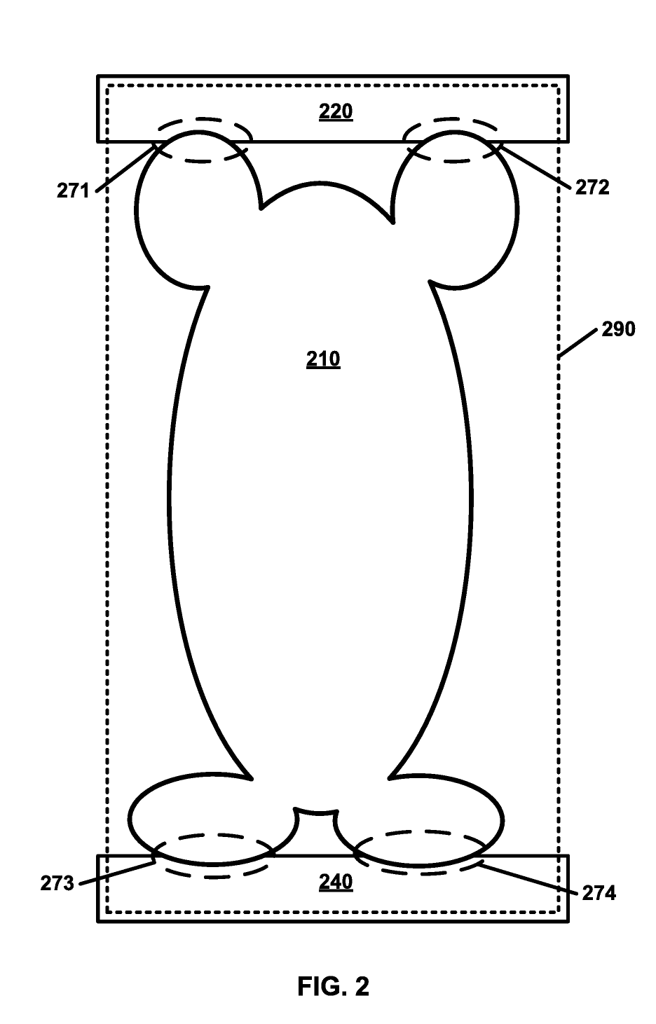

Example FIG. 2 is a diagram of a shaped door cover mounted on a door as per an aspect of an embodiment of the present invention.

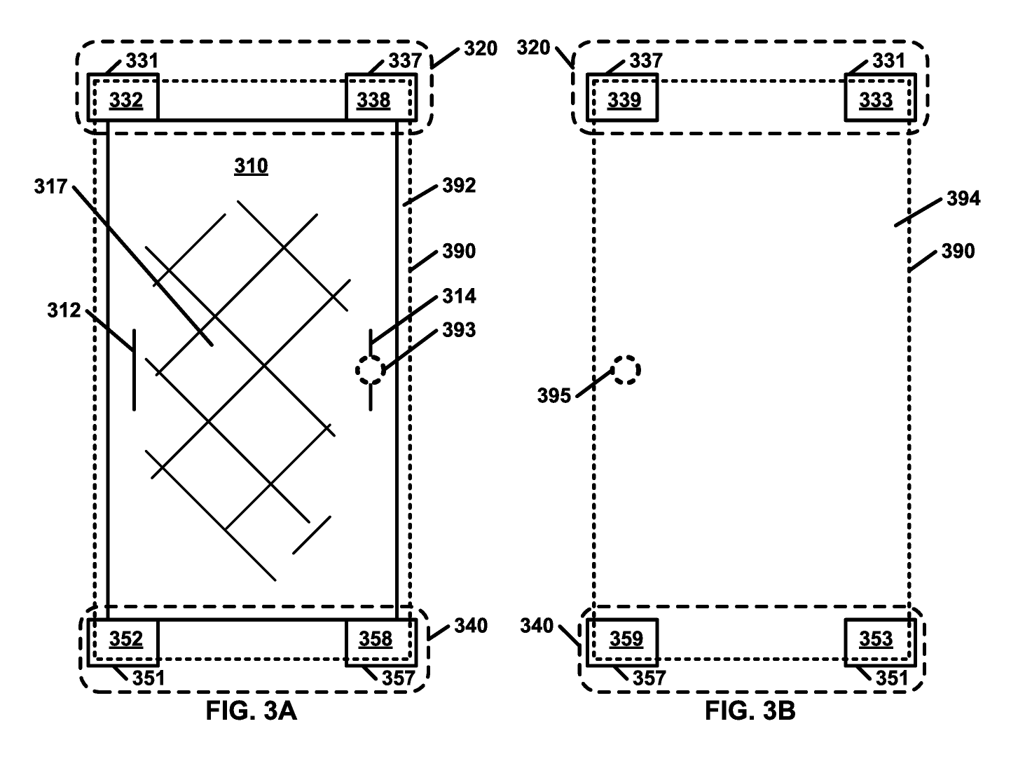

Example FIG. 3A is a front view diagram of a door cover mounted on a door as per an aspect of an embodiment of the present invention.

Example FIG. 3B is a rear view diagram of a door cover mounted on a door as per an aspect of an embodiment of the present invention.

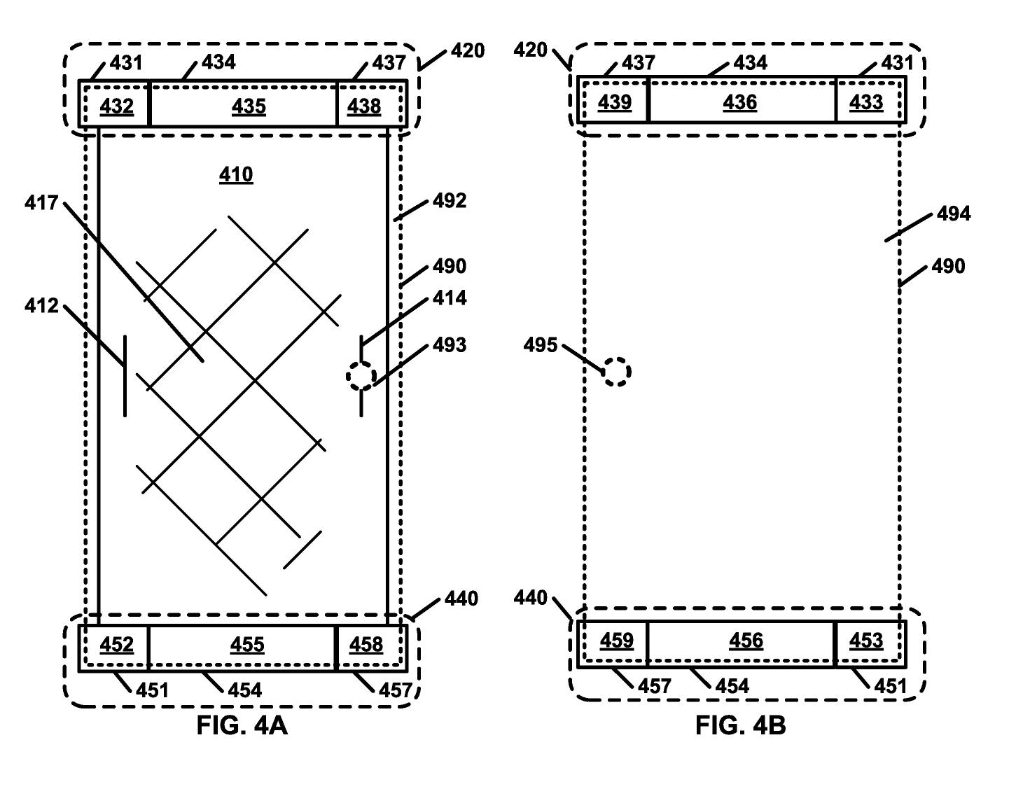

Example FIG. 4A is a front view diagram of a door cover mounted on a door as per an aspect of an embodiment of the present invention.

Example FIG. 4B is a rear view diagram of a door cover mounted on a door as per an aspect of an embodiment of the present invention.

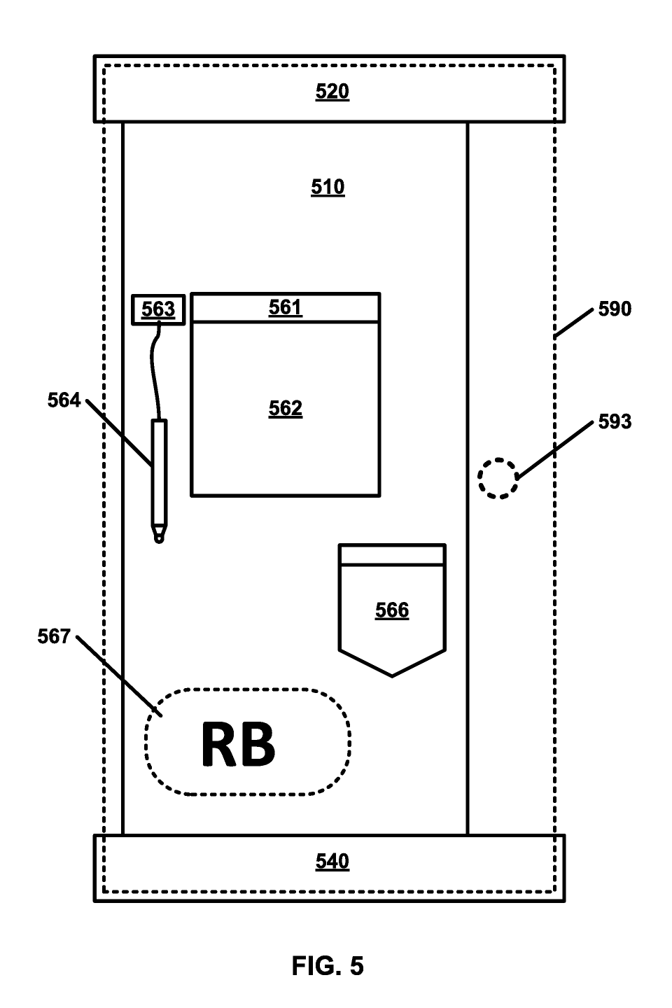

Example FIG. 5 is a diagram of a door cover with accessories mounted on a door as per an aspect of an embodiment of the present invention.

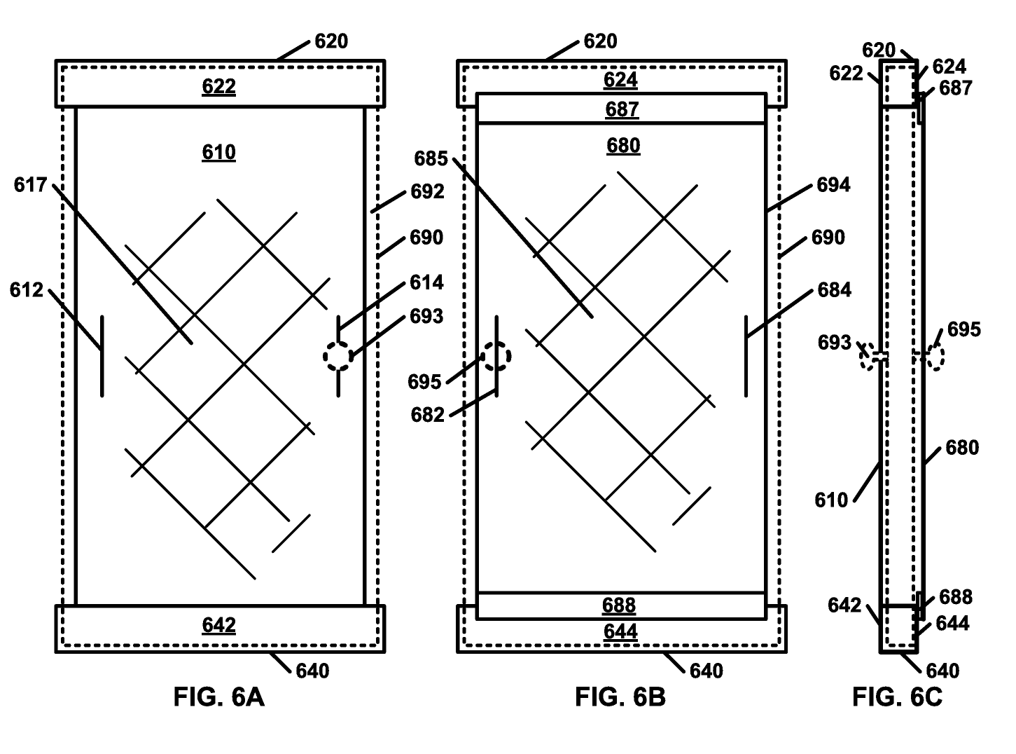

Example FIG. 6A is a front view diagram of a door cover mounted on a door as per an aspect of an embodiment of the present invention.

Example FIG. 6B is a rear view diagram of a door cover mounted on a door as per an aspect of an embodiment of the present invention.

Example FIG. 6C is a side view diagram of a door cover mounted on a door as per an aspect of an embodiment of the present invention.

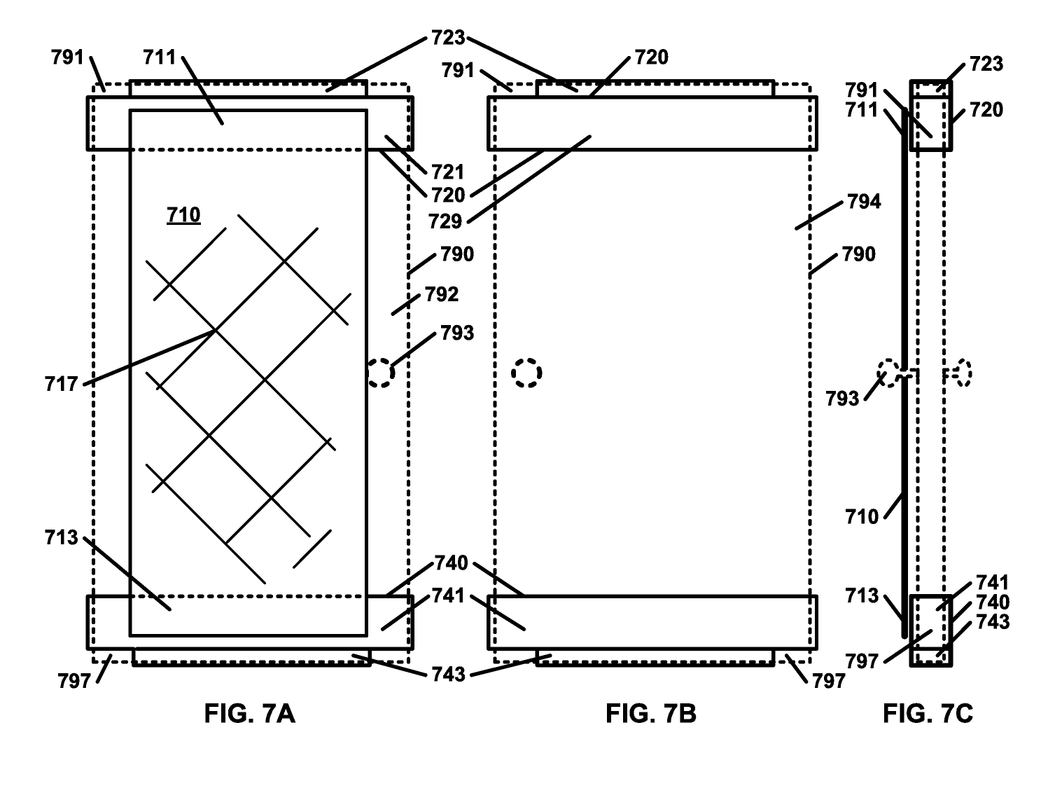

Example FIG. 7A is a front view diagram of a door cover mounted on a door as per an aspect of an embodiment of the present invention.

Example FIG. 7B is a rear view diagram of a door cover mounted on a door as per an aspect of an embodiment of the present invention.

Example FIG. 7C is a side view diagram of a door cover mounted on a door as per an aspect of an embodiment of the present invention.

### DETAILED DESCRIPTION OF EMBODIMENTS

Embodiments of the present invention cover at least part of a door. The cover may comprise flexible sleeves that may fit over the top and/or bottom of the door. A panel attached to the sleeves may comprise images and/or accessories.

Embodiments of the invention will be described with reference to the accompanying drawings, wherein like reference numerals designate like structural elements. It should be understood that the following descriptions are not intended to limit the embodiments to one preferred embodiment. To the contrary, it is intended to cover alternatives, modifications, and equivalents as may be included within the spirit and scope of the described embodiments as defined by the appended claims.

Example FIG. 1A is a front view diagram of a door cover mounted on a door 190 as per an aspect of an embodiment of the present invention. Example FIG. 1B is a rear view diagram of a door cover mounted on a door 190 as per an aspect of an embodiment of the present invention. Example FIG. 1C is a side view diagram of a door cover mounted on a door 190 as per an aspect of an embodiment of the present invention.

According to some of the various embodiments of the present invention, a door covering apparatus may comprise a panel 110, an upper elastic sleeve 120, and a lower elastic sleeve 140.

According to some of the various embodiments, the panel 110 may comprise an upper left panel corner, an upper right panel corner, a lower left panel corner, and a lower right panel corner. The panel 110 may be configured to cover at least part of first side of a door 190. The door 190 may comprise an upper left door corner, an upper right door corner, a lower left door corner and a lower right door corner.

According to some of the various embodiments, the upper elastic sleeve 120 may be attached to the upper left panel corner, the upper right panel corner, a combination thereof, and/or the like. The upper elastic sleeve 120 may be configured to attach to the upper left door corner, the upper right door corner, a combination thereof, and/or the like. As illustrated, upper elastic sleeve 120 may have a front side 122 and/or a rear side 124. The sleeve may be stretched over door 190 with the front side 122 capping the front side of the door 192 and the rear side 124 capping the rear side of the door. The upper sleeve 120 may be configured with enough elasticity to hold onto the door 190 without significantly hindering the operation of the door 190.

According to some of the various embodiments, the lower elastic sleeve 140 may be attached to the lower left panel corner, the lower right panel corner, a combination thereof, and/or the like. The lower elastic sleeve 140 may be configured to attach to the lower left door corner, the lower right door corner, a combination thereof, and/or the like. As illustrated, lower elastic sleeve 140 may have a front side 142 and/or a rear side 144. The sleeve may be stretched over door 190 with the front side 142 capping the front side of the door 192 and the rear side 144 capping the rear side of the door. The lower sleeve 140 may be configured with enough elasticity to hold onto the door 190 without significantly hindering the operation of the door 190.

In yet other embodiments, the upper sleeve 120 may be attached to a significant portion of the upper edge of the panel 110. Similarly, the lower elastic sleeve 140 may be attached to a significant portion of the lower edge of panel 110.

Various mechanisms may be employed to attach parts of panel 110 to sleeve(s) 120 and/or 140. For example, upper elastic sleeve 120 and/or lower elastic sleeve 140 may be attached to panel 110 with thread, glue, a heat weld, a chemical weld, an adhesive, an adhesive patch, a connector, combinations thereof, and/or the like. An example of an adhesive patch comprises, but is not limited to Velcro™ Examples of connectors comprise, but are not limited to: buckles, snaps, hooks, buttons, combinations thereof, and/or the like. A heat weld may be applied by melting two materials together. A chemical weld may be applied by melting two materials together using a solvent. In yet other embodiments, parts of panel 110 to sleeve(s) 120 and/or 140 may be manufactured attached. For example, parts of panel 110 to sleeve(s) 120 and/or 140 may be molded together, and or sewn together from a single piece of material.

According to some of the various embodiments, the panel 110 may comprise at least one of the following: a synthetic material; a polyester knitted material; a natural material; a material comprising organic fibers, a combination of the above, and/or the like. Many of the various synthetic materials are man-made. Examples of synthetic materials that may be employed comprise: nylon, polyester, spandex, Acetate, Cupro, Flannel, Lyocell, PVC-Polyvinyl chloride, Rayon, Recycled or Recovered Cotton, Recycled PET, Recycled paper, and Tyvek. Other examples of synthetic materials that may be employed comprise: Be.tex® Revolution FR, made by Berger Textils, a 100% polyester, synthetic, knitted fabric with a weight of 180 g/m(2); Re.tex Revolution FR, made by Berger Textils, a 100% recycled polyester, synthetic, knitted fabric with a weight of 180 g/m(2); Eco Display light 180 FR+w, made by Berger Textils, a 100% polyester, synthetic, knitted fabric with a weight of 170 g/m(2); Be.tex® Samba FR, made by Berger Textils, a 100% polyester, synthetic, woven fabric with a weight of 195 g/m(2), combinations thereof, and/or the like. Some of the various natural materials comprise: fabric made of cotton, flax, wool, ramie, silk, denim, leather, bamboo, wood, fur, combinations thereof, and/or the like.

The panel 110 may comprise material with various properties. For example, according to some of the various embodiments, material with at least some of the following properties may be employed: materials with an elasticity of less than 3%; material configured to be soft, material configured to minimize creases, material that comprises a UV protective coating, material that is fire retardant, material that is transparent, combinations thereof, and/or the like.

According to some of the various embodiments, various techniques may be employed to prevent raveling of edge of material. For example, at least part of the panel comprises a heat cut edge. A heat cut edge may fuse fiber together when cut to prevent the unraveling of the material on the cut edge. Other techniques to seal the edge of the material may comprise: hemming, cutting the material with a pattern (e.g. zig-zag), applying an overcast stitch, stitching a seam along the edge, applying a sealant along the edge, combinations thereof, and/or the like.

According to some of the various embodiments, the panel 110 may further comprise additional attachment mechanism(s) to connect the panel 110 to door 190 comprising, but not limited to: adhesive, adhesive patches, magnets, combinations thereof, and/or the like.

According to some of the various embodiments, at least part of the panel 110 may comprise one or more images 117. At least part of the image may be applied employing at least one of the following techniques: screen printing, digital printing, stencil printing, perrotine printing, roller printing, cylinder printing, machine printing, combinations thereof, and/or the like. Perrotine printing may employ a block-printing machine. Roller, cylinder, or machine printing may employ engraved plate(s) to print textiles with a multitude of colors. Stencil printing may comprise applying a fabric ink through uncut portions of a stencil. In screen printing, printing paste may be squeegeed via a blade through openings in a screen onto a material. Two types of screen printing devices that may be employed comprise, without limitation, rotary screen printing and flat (bed) screen printing.

At least part of the image 117 may be applied employing a sublimation printing process. Sublimation printing may employ a digital printing process that uses heat to transfer dye onto materials such as fabric materials and polyester and polymer-coated substrates. The sublimation process may make the transition between the solid and gas states without going through a liquid stage. All or part of the panel 110 may be heat set for sublimation printing. Heat setting seals the ink that creates the image and prevents cracking.

Printing onto nylon and silk may employ an ink such as, for example, an acid ink. Reactive ink may be employed to print on cellulose based fibers such as cotton and linen.

According to some of the various embodiments, at least part of the image 117 may be applied to the panel 110 when the panel fabric is made. For example, image 117 may be knitted into the panel 110. An image 117 may also be embroidered into the panel. In other embodiments, the image 117 may be impressed on to the panel 110. In yet other embodiments, the image 117 may be molded onto the panel 110. It is envisioned that other techniques may also be employed that result in an identifiable image 117 becoming present on panel 110.

According to some of the various embodiments, at least part of the panel 110 may comprise at least one slit (e.g. 112 and/or 114). The slit(s) (e.g. 112 and/or 114) may be configured to accommodate a doorknob. As illustrated, doorknob 193 is illustrated protruding from the front side 192 of door 190 through slit 114. According to some of the various embodiments, at least part of the panel 110 may comprise additional slit(s) to accommodate other protrusions such as, but not limited to, door pulls, hangers, knockers, combinations thereof, and/or the like.

According to some of the various embodiments, at least one of the slit(s) (e.g. 112 and/or 114) may be sealed with a material such as, but not limited to, an adhesive tape, a transparent adhesive tape, a reusable adhesive tape, combinations thereof, and/or the like. The slit(s) (e.g. 112 and/or 114) may be sealed, according to various embodiments on the front and/or rear of panel 110.

Example FIG. 2 is a diagram of a shaped door cover mounted on a door 290 as per an aspect of an embodiment of the present invention. According to some of the various embodiments, at least part of the panel 210 may be shaped. In other words, the panel 210 may have a shape other than a rectangular shape. Based upon the specific shape of the panel 210, the panel may connect at various points to the upper elastic sleeve 220 and lower elastic sleeve 240. For the sake of interpretation, these connection points may, for example, be equivalent to the upper left panel corner 271, upper right panel corner 272, lower left panel corner 273, and/or lower right panel corner 274.

Example FIG. 3A is a front view diagram of a door cover mounted on a door 390 as per an aspect of an embodiment of the present invention. Example FIG. 3B is a rear view diagram of a door cover mounted on a door 390 as per an aspect of an embodiment of the present invention.

According to some of the various embodiments, an upper elastic sleeve 320 may comprise: an upper left elastic sleeve 331 and an upper right elastic sleeve 337. As illustrated, upper left elastic sleeve 331 may have a front side 332 and/or a rear side 333. The front 332 of upper left elastic sleeve 331 may be attached to the upper left panel corner of panel 310. The upper left elastic sleeves 331 may be configured to be stretched over door 390 with the front side 332 covering at least a part of the front side of the door 392 and the rear side 333 covering at least a part of the rear side of the door 394 without significantly hindering the operation of the door 390. As illustrated, upper right elastic sleeve 337 may have a front side 338 and/or a rear side 339. The front 338 of upper right elastic sleeve 337 may be attached to the upper right panel corner of panel 310. The upper right elastic sleeve 337 may be configured to be stretched over door 390 with the front side 338 covering at least a part of the front side of the door 392 and the rear side 339 covering at least a part of the rear side of the door 394 without significantly hindering the operation of the door 390. Together, the upper elastic sleeve(s) 331 and/or 337 may be configured with enough elasticity to hold onto door 390 without significantly hindering the operation of the door 390. According to some of the various embodiments, the upper elastic sleeve(s) 331 and/or 337 may be configured to attach to other locations of panel 310. This may be especially true when panel 310 is shaped.

According to some of the various embodiments, a lower elastic sleeve 340 may comprise: a lower left elastic sleeve 351 and a lower right elastic sleeve 357. As illustrated, lower left elastic sleeve 351 may have a front side 352 and/or a rear side 353. The front 352 of lower left elastic sleeve 351 may be attached to the lower left panel corner of panel 310. The lower left elastic sleeves 351 may be configured to be stretched under door 390 with the front side 352 covering at least a part of the front side of the door 392 and the rear side 353 covering at least a part of the rear side of the door 394 without significantly hindering the operation of the door 390. As illustrated, lower right elastic sleeve 357 may have a front side 358 and/or a rear side 359. The front 358 of lower right elastic sleeve 357 may be attached to the lower right panel corner of panel 310. The lower right elastic sleeves 357 may be configured to be stretched under door 390 with the front side 358 covering at least a part of the front side of the door 392 and the rear side 359 covering at least a part of the rear side of the door 394 without significantly hindering the operation of the door 390. Together, the lower elastic sleeve(s) 351 and/or 357 may be configured with enough elasticity to hold onto door 390 without significantly hindering the operation of the door 390. According to some of the various embodiments, the lower elastic sleeve(s) 351 and/or 357 may be configured to attach to other locations of panel 310. This may be especially true when panel 310 is shaped

According to some of the various embodiments, at least one of the upper elastic sleeve and the lower elastic sleeve may comprise material with various characteristics. For example, at least one of the upper elastic sleeve and the lower elastic sleeve comprise an abrasive resistant material, a multi-stretch fabric (e.g. 3 or 4-way stretch fabric), combinations thereof, and/or the like. According to some of the various embodiments, at least one of the upper elastic sleeve and the lower elastic sleeve comprises materials such as, but not limited to: SPANDEX™, SPANDURA™ a synthetic elastic material combining Vinyl and SPANDEX™, a combination of the above, and/or the like.

According to some of the various embodiments, the apparatus may be configured so that the upper elastic sleeve(s) 331 and/or 337, and the lower elastic sleeve(s) 351 and/or 357 fit a door between 28 and 32 inches wide. According to some of the other embodiments, the apparatus may be configured so that the upper elastic sleeve(s) 331 and/or 337, and the lower elastic sleeve(s) 351 and/or 357 fit a door between 32 and 48 inches wide. In yet other embodiments, the apparatus may be configured so that the upper elastic sleeve(s) 331 and/or 337, and the lower elastic sleeve(s) 351 and/or 357 fit a door between 28 and 48 inches wide.

According to some of the various embodiments, and as illustrated, the panel 310 may comprise an image 317, a slit 312, a slit 314, combinations thereof, and/or the like. Slit 314, as illustrated, may be configured to allow a doorknob 393 to protrude through panel 310.

Example FIG. 4A is a front view diagram of a door cover mounted on a door 410 as per an aspect of an embodiment of the present invention. Example FIG. 4B is a rear view diagram of a door cover mounted on a first side of a door as per an aspect of an embodiment of the present invention.

According to some of the various embodiments, an upper elastic sleeve 420 may comprise: an upper left elastic sleeve 431, at least one upper center sleeve 434 and an upper right elastic sleeve 437. As illustrated, upper center sleeve(s) 434 may be disposed between upper left elastic sleeve 431 and upper right elastic sleeve 437 and may comprise a front side 435 and a back side 436. Upper left elastic sleeve 431 may have a front side 432 and/or a rear side 433. The front 432 of upper left elastic sleeve 431 may be attached to the upper left panel corner of panel 410. The upper left elastic sleeves 431 may be configured to be stretched over door 490 with the front side 432 covering at least a part of the front side of the door 492 and the rear side 439 covering at least a part of the rear side of the door 494 without significantly hindering the operation of the door 490. As illustrated, upper right elastic sleeve 437 may have a front side 438 and/or a rear side 439. The front 438 of upper right elastic sleeve 437 may be attached to the upper right panel corner of panel 410. The upper right elastic sleeve 437 may be configured to be stretched over door 490 with the front side 438 covering at least a part of the front side of the door 492 and the rear side 439 covering at least a part of the rear side of the door 494 without significantly hindering the operation of the door 490. Together, the upper elastic sleeve(s) 431, 434, and/or 437 may be configured with enough elasticity to hold onto door 490 without significantly hindering the operation of the door 490. According to some of the various embodiments, the upper elastic sleeve(s) 431, 434, and/or 437 may be configured to attach to other locations of panel 410. This may be especially true when panel 410 is shaped.

According to some of the various embodiments, a lower elastic sleeve 440 may comprise: a lower left elastic sleeve 451, at least one lower center sleeve 454, and a lower right elastic sleeve 457. As illustrated, lower center sleeve(s) 454 may be disposed between lower left elastic sleeve 451 and lower right elastic sleeve 457 and may comprise a front side 455 and a back side 456. As illustrated, lower left elastic sleeve 451 may have a front side 452 and/or a rear side 453. The front 452 of lower left elastic sleeve 451 may be attached to the lower left panel corner of panel 410. The lower left elastic sleeves 451 may be configured to be stretched under door 490 with the front side 452 covering at least a part of the front side of the door 492 and the rear side 453 covering at least a part of the rear side of the door 494 without significantly hindering the operation of the door 490. As illustrated, lower right elastic sleeve 457 may have a front side 458 and/or a rear side 459. The front 458 of lower right elastic sleeve 457 may be attached to the lower right panel corner of panel 410. The lower right elastic sleeves 457 may be configured to be stretched under door 490 with the front side 458 covering at least a part of the front side of the door 492 and the rear side 459 covering at least a part of the rear side of the door 494 without significantly hindering the operation of the door 490. Together, the lower elastic sleeve(s) 451, 454, and/or 457 may be configured with enough elasticity to hold onto door 490 without significantly hindering the operation of the door 490. According to some of the various embodiments, the lower left elastic sleeve(s) 451, 454, and/or 457 may be configured to attach to other locations of panel 410. This may be especially true when panel 410 is shaped.

According to some of the various embodiments, at least one of the upper elastic sleeve and the lower elastic sleeve may comprise material with various characteristics. For example, at least one of the upper elastic sleeve and the lower elastic sleeve comprise an abrasive resistant material, a multi-stretch fabric (e.g. 3 or 4-way stretch fabric), combinations thereof, and/or the like. According to some of the various embodiments, at least one of the upper elastic sleeve and the lower elastic sleeve comprises materials such as, but not limited to: SPANDEX™, SPANDURA™ a synthetic elastic material combining Vinyl and SPANDEX™, a combination of the above, and/or the like.

According to some of the various embodiments, the apparatus may be configured so that the upper elastic sleeve(s) 431, 434, and/or 437, and the lower elastic sleeve(s) 451, 454, and/or 457 fit a door between 28 and 32 inches wide. According to some of the other embodiments, the apparatus may be configured so that the upper elastic sleeve(s) 431, 434, and/or 437, and the lower elastic sleeve(s) 451, 454, and/or 457 fit a door between 32 and 48 inches wide. In yet other embodiments, the apparatus may be configured so that the upper elastic sleeve(s) 431, 434, and/or 437, and the lower elastic sleeve(s) 451, 454, and/or 457 fit a door between 28 and 48 inches wide.

According to some of the various embodiments, and as illustrated, the panel 410 may comprise an image 417, a slit 412, a slit 414, combinations thereof, and/or the like. Slit 414, as illustrated, may be configured to allow a doorknob 493 to protrude through panel 410.

Throughout this description, multiple sleeve configurations and embodiments have been described. It is envisioned that these sleeve configurations and embodiments may be employed in various embodiments in various combinations, some of which are described below. So, for example, according to some of the various embodiment, the top half of a panel may be attached to an upper sleeve as described with respect to FIGS. 1A, 1B, and 1C while the lower half of a panel may be attached to a lower sleeve as described with respect to FIGS. 3A and 3B. Similarly, according to some of the various embodiment, the top half of a panel may be attached to an upper sleeve as described with respect to FIGS. 4A and 4B while the lower half of a panel may be attached to a lower sleeve as described with respect to FIGS. 3A and 3B. In yet other embodiments, the top half of a panel may be attached to an upper sleeve as described with respect to FIGS. 4A and 4B while the lower half of a panel may be attached to a lower sleeve as described with respect to FIGS. 1A, 1B and 1C.

Example FIG. 5 is a diagram of a door cover with example accessories (e.g. 562, 564, 566 and/or 567) mounted on a door 590 as per an aspect of an embodiment of the present invention.

According to some of the various embodiments, and as illustrated in FIG. 5, various accessories may be attached to panel 510. Some of the accessories may be permanently attached to panel 510, while other embodiments may be removable. Accessories may comprise, but are not limited to: writing implement(s) 564, board(s) 562 (e.g. chalk board(s), white board(s), bulletin board(s), cork board(s), etc.), personalizations 567, poster(s), picture frame(s), picture(s), poster clip(s), clothing clip(s), erasable material, mirror(s), combinations thereof, and/or the like. For example, a pocket 566 may be disposed on panel 510. The pocket 566 may be configured to store items on a door. A pocket 566 may also be configured as a channel to allow other accessories to be connected to panel 510.

At least one attachment mechanism (e.g. 563 and/or 561) may be disposed on panel 510. For example, attachment mechanism 563 may be employed to hold writing implement 564 via string to panel 510. Additionally, attachment mechanism 561 may be employed to hold board 562 to panel 510. Attachment mechanisms may comprise, but are not limited to: Velcro™, string(s), clip(s), sewn channel(s) combinations thereof, and/or the like.

According to some of the various embodiments, installation information may be provided on one or more of the apparatus components such as for example, the back of panel 510, the back of upper elastic sleeve 520, lower elastic sleeve 540, combinations thereof, and/or the like. Further, some of the various embodiments may comprise at least one alignment line printed on the apparatus to assist with the mounting of apparatus on door 590 and/or to assist with the mounting of one or more accessories on panel 510.

According to some of the various embodiments, personalizations (e.g. 567) may comprise a monogram. According to other embodiments, personalizations may comprise embroidery, pictures, combinations thereof, and/or the like. Some of the various embodiments may also comprise other customizations such as an embroidered portion on at least part of panel 510, an owner identification portion on at least part of panel 510, combinations thereof, and/or the like.

According to some of the various embodiments, the apparatus may be configured to be foldable into a storage configuration such as, but not limited to fitting within a pocket, fitting within one of, or a part of the upper elastic sleeve 520 and/or the lower elastic sleeve 540. This storage configuration may be employed to store the apparatus.

Although many of the embodiments shown include slots to allow objects like doorknobs to pass, it is envisioned that other embodiments comprise shapes where panel avoids obstructions. For example, panel 510, as illustrated, is sized to avoid doorknob 593. Similarly, other shapes may be employed that avoid yet other obstruction\s and/or objects such as door knockers, peep holes, hooks, combinations thereof, and/or the like.

Example FIG. 6A is a front view diagram of a two-sided door cover mounted on a door 690 as per an aspect of an embodiment of the present invention. Example FIG. 6B is a rear view diagram of a two-sided door cover mounted on a door 690 as per an aspect of an embodiment of the present invention. Example FIG. 6C is a side view diagram of a two-sided door cover mounted on a door 690 as per an aspect of an embodiment of the present invention.

FIG. 6A illustrates a door covering mounted on a door 690. The front of the door 692 is partially covered by panel 610 connected to the front 622 of upper elastic sleeve 620 and front 642 of lower elastic sleeve 640. Panel 610 comprises an image 617 and two slits 612 and 614. Slit 614 is positioned to allow doorknob 693 to protrude.

As shown in FIGS. 6B and 6C, the rear of the door 694 is partially covered by panel 680. Panel 680 may be connected to the rear 624 of upper elastic sleeve 620 and rear 644 of lower elastic sleeve 640 via attachment mechanisms 687 and 688 respectively. Attachment mechanism(s) 687 and/or 688 may comprise a number of attachment mechanisms discussed earlier comprising, but not limited to Velcro™ grommets, hooks, snaps, buttons, combinations thereof, and/or the like. As illustrated in this example embodiment, additional panel 680 comprises an image 685 and two slits 682 and 684. Slit 682 is positioned to allow doorknob 695 to protrude.

Fastening mechanisms may be configured to avoid sagging of back panel 680. For example, an attachment mechanism may comprise, for example, a multitude of grommets on the top and bottom of panel 680.

Example FIG. 7A is a front view diagram of a door cover mounted on a door 790 as per an aspect of an embodiment of the present invention. Example FIG. 7B is a rear view diagram of a door cover mounted on a door 790 as per an aspect of an embodiment of the present invention. Example FIG. 7C is a side view diagram of a door cover mounted on a door 790 as per an aspect of an embodiment of the present invention.

A panel 710 may comprise an upper panel portion 711 and a lower panel portion 712. The panel 710 may be configured to cover at least part of first side 792 of a door 790. As illustrated, the panel 710 in this embodiment may be sized to avoid the door knob 793. The door 790 may comprise: an upper door portion 791, and a lower door portion 797.

An upper elastic sleeve 720 may be attached to the upper panel portion 711. The upper elastic sleeve 720 may comprise an upper horizontal band configured to circumnavigate the width of at least a portion of the upper door portion 791. The upper horizontal band may comprise a first upper horizontal portion 721 and a second horizontal portion 729. According to an embodiment, the first horizontal portion 721 may be configured to reside on the first side 792 of the door 790 when installed on door 790. According to an embodiment, the second horizontal portion 729 may be configured to reside on the second side 794 of the door 790 when installed on door 790. An upper connecting portion 723 may be configured to connect, over the top of the door 790, the first upper horizontal portion 721 with the second upper horizontal portion 729.

A lower elastic sleeve 740 may be attached to the lower panel portion 713. The lower elastic sleeve 740 may comprise a lower horizontal band configured to circumnavigate the width of at least a portion of the lower door portion 791. The lower horizontal band may comprise a first lower horizontal portion 741 and a second lower horizontal portion 749. According to an embodiment, the first lower horizontal portion 741 may be configured to reside on the first side 792 of the door 790 when installed on door 790. According to an embodiment, the second lower horizontal portion 749 may be configured to reside on the second side 794 of the door 790 when installed on door 790. A lower connecting portion 743 may be configured to connect, under the bottom of the door 790, the first lower horizontal portion 741 with the second lower horizontal portion 749.

According to an embodiment, at least part of the panel 710 may comprise a material with an elasticity of less than 3%. According to an embodiment, the 710 may comprise at least one of the following: a synthetic material, a polyester knitted material, a natural material, a material comprising organic fibers, an ultraviolet (UV) protective coating, a crease resistant material, a soft material, a heat cut edge, a heat set compatibility, a fire retardant material, a transparent material, an image 717, a combination thereof, and/or the like. According to an embodiment, at least part of the image 717 may be applied employing at least one of the following: sublimation printing, screen printing, digital printing, stencil printing, perrotine printing, roller printing, cylinder printing, machine printing, a combination thereof, and/or the like. According to an embodiment, at least part of the panel 710 may be shaped.

According to an embodiment, the upper elastic sleeve 720 may comprise one or more of: an upper left elastic sleeve, an upper right elastic sleeve, an upper center sleeve, a combination thereof, and/or the like. According to an embodiment, the lower elastic sleeve 740 may comprise one or more of: a lower left elastic sleeve, a lower right elastic sleeve, a lower center sleeve, a combination thereof, and/or the like. According to an embodiment, at least one of the upper elastic sleeve 720 and the lower elastic sleeve 740 may comprise a 4-way stretch fabric. According to an embodiment, at least one of the upper elastic sleeve 720 and the lower elastic sleeve 740 may comprise at least one of the following materials: an abrasive resistant material, SPANDEX™, SPANDURA™, a synthetic elastic material combining Vinyl and SPANDEX™; a combination thereof, and/or the like. According to an embodiment, at least one of the upper elastic sleeve 720 and the lower elastic sleeve 740 may be configured to fit a door between 28 and 48 inches wide.

According to an embodiment, at least one of the upper elastic sleeve 720 and the lower elastic sleeve 740 may be attached to the panel 710 with at least one of the following: a thread, a heat weld, glue, an adhesive, an adhesive patch, a combination thereof, and/or the like. According to an embodiment, at least one of the upper elastic sleeve 720 and the lower elastic sleeve 740 may be integrally manufactured with the panel 710. So for example, an elastic sleeve (e.g. 720 and/or 740) and a panel 710 may be cut or woven as a single unit. According to an embodiment, at least part of the rear of the panel 710 may further comprise an adhesive. According to an embodiment, at least part of the panel 710 may further comprise an owner identification portion. According to an embodiment, at least one pocket may be disposed upon the panel 710. According to an embodiment, at least one attachment mechanism may be disposed upon the panel 710 and be configured to attach to at least one attachable accessory. According to an embodiment, at least one additional panel 710 may be configured to attach to the rear of at least one of the following: the upper elastic sleeve 720 and/or the lower elastic sleeve 740. The additional panel 710 may be configured to cover at least part of the rear 794 of the door 790.

According to an embodiment, the apparatus may be configured to be foldable into at least one of the following: the upper elastic sleeve 720, the lower elastic sleeve 740, a pocket, a channel, a combination thereof, and/or the like. An embodiment may further comprise installation information printed on the apparatus. According to an embodiment, the installation information may comprise at least one alignment line.

In this specification, “a” and “an” and similar phrases are to be interpreted as “at least one” and “one or more.” References to “an” embodiment in this disclosure are not necessarily to the same embodiment.

The disclosure of this patent document incorporates material that is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of covering a door. However, one skilled in the art will recognize that embodiments of the invention could be employed to cover other objects such as, but not limited to: boxes, display cases, automobiles, buildings, combinations thereof, and/or the like.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1. An apparatus comprising:
a. a panel:
i. comprising:
1. an upper panel portion; and
2. a lower panel portion; and
ii. configured to cover at least part of first side of a door, the door comprising:
1. an upper door portion; and
2. a lower door portion;
b. an upper elastic sleeve:
i. attached to the upper panel portion; and
ii. comprising:
1. an upper horizontal band configured to circumnavigate the width of at least a portion of the upper door portion, the upper horizontal band comprising a first upper horizontal portion and a second horizontal portion; and
2. an upper connecting portion configured to connect, over the top of the door, the first upper horizontal portion with the second upper horizontal portion; and
c. a lower elastic sleeve:
i. attached to the lower panel portion; and
ii. comprising:
1. a lower horizontal band configured to circumnavigate the width of at least a portion of the lower door portion, the lower horizontal band comprising a first lower horizontal portion and a second lower horizontal portion; and
2. a lower connecting portion configured to connect, under the bottom of the door, the first lower horizontal portion with the second lower horizontal portion.

2. The apparatus according to claim 1, wherein at least part of the panel comprises a material with an elasticity of less than 3%.

3. The apparatus according to claim 1, wherein the panel comprises at least one of the following:
a. a synthetic material;
b. a polyester knitted material;
c. a natural material;
d. a material comprising organic fibers;
e. an ultraviolet (UV) protective coating;
f. a crease resistant material;
g. a soft material;
h. a heat cut edge;
i. a heat set compatibility;
j. a fire retardant material;
k. a transparent material; and
l. an image.

4. The apparatus according to claim 1, wherein at least part of the image was applied employing at least one of the following:
a. sublimation printing
b. screen printing;
c. digital printing;
d. stencil printing;
e. perrotine printing;
f. roller printing;
g. cylinder printing; and
h. machine printing.

5. The apparatus according to claim 1, wherein at least part of the panel is shaped.

6. The apparatus according to claim 1, wherein the upper elastic sleeve further comprises one or more of:
a. an upper left elastic sleeve;
b. an upper right elastic sleeve; and
c. an upper center sleeve.

7. The apparatus according to claim 1, wherein the lower elastic sleeve further comprises one or more of:
a. a lower left elastic sleeve;
b. a lower right elastic sleeve; and
c. a lower center sleeve.

8. The apparatus according to claim 1, wherein at least one of the upper elastic sleeve and the lower elastic sleeve comprises a 4-way stretch fabric.

9. The apparatus according to claim 1, wherein at least one of the upper elastic sleeve and the lower elastic sleeve comprises at least one of the following materials:
a. an abrasive resistant material;
b. SPANDEX™;
c. SPANDURA™; and
d. a synthetic elastic material combining Vinyl and SPANDEX™.

10. The apparatus according to claim 1, wherein at least one of the upper elastic sleeve and the lower elastic sleeve are configured to fit a door between 28 and 48 inches wide.

11. The apparatus according to claim 1, further comprises installation information printed on the apparatus.

12. The apparatus according to claim 11, wherein the installation information comprises at least one alignment line.

13. The apparatus according to claim 1, wherein at least one of the upper elastic sleeve and the lower elastic sleeve is attached to the panel with at least one of the following:
a. thread;
b. a heat weld;
c. glue;
d. adhesive; and
e. an adhesive patch.

14. The apparatus according to claim 1, wherein at least one of the upper elastic sleeve and the lower elastic sleeve is integrally manufactured with the panel.

15. The apparatus according to claim 1, wherein at least part of the rear of the panel further comprises an adhesive.

16. The apparatus according to claim 1, wherein at least part of the panel further comprises an owner identification portion.

17. The apparatus according to claim 1, further comprising at least one pocket disposed upon the panel.

18. The apparatus according to claim 1, further comprising at least one attachment mechanism disposed upon the panel configured to attach to at least one attachable accessory.

19. The apparatus according to claim 1, wherein the apparatus is configured to be foldable into at least one of the following:
a. the upper elastic sleeve;
b. the lower elastic sleeve;
c. a pocket; and
d. channel.

20. The apparatus according to claim 1, further comprising at least one additional panel configured to:
a. attach to the rear of at least one of the following:
i. the upper elastic sleeve; and
ii. the lower elastic sleeve; and
b. cover at least part of the rear of the door.
